(19) United States
(12) Patent Application Publication
(10) Pub. No.: US 2002/0066404 A1
(43) Pub. Date: Jun. 6, 2002

(54) Curtain applicator

(76) Inventors: Manfred Ueberschar, Gerstetten (DE); Benjamin Mendez-Gallon, Konigsbronn (DE)

Correspondence Address: TAYLOR & AUST, P.C., 142 S. Main St., P.O. Box 560, Avilla, IN, 46710, US

(21) Appl. No.: 09/996,304

(22) Filed: Nov. 21, 2001

(30) Foreign Application Priority Data
Nov. 22, 2000 (DE) 10057729.6

(51) Int. Cl. B05C 1/06

(52) U.S. Cl. 118/261

(57) ABSTRACT

An apparatus is configured for applying at least one first layer of a first application medium and at least one second layer of a second application medium to a material web, either directly or indirectly. The at least one first layer and the at least one second layer each are first applied onto a moving base (either the web surface in the case of direct application or a transfer element in the case of indirect application). The apparatus includes a first curtain applicator unit having a first discharge nozzle and configured for discharging the first application medium through the first discharge nozzle in a form of a first curtain onto the moving base. The apparatus also incorporates a second curtain applicator unit which includes a second discharge nozzle and which is configured for discharging the second application medium through the second discharge nozzle in a form of a second curtain onto the moving base. The first applicator unit is positioned relative to the second applicator unit such that a spacing of about 100 mm to about 500 mm separates the first curtain and the second curtain.

### BACKGROUND OF THE INVENTION

1. Field of the Invention

The invention relates to an apparatus for applying at least a first layer and at least a second layer of liquid or pasty application medium, especially an aqueous pigment suspension, to a moving base, the base in the case of direct application being the surface of a material web, especially a paper or cardboard web, and in the case of indirect application being the surface of a transfer element, preferably a transfer roll, which then transfers the application medium to the surface of the material web, each of the at least first layer and the at least second layer being applied onto the base from a discharge nozzle as a curtain or veil which moves substantially under the force of gravity.

2. Description of the Related Art

The movement of the application medium curtain “substantially under the force of gravity” is understood to mean that, of all the forces which drive the application medium towards the base, the force of gravity exerts the greatest influence on the application medium curtain. However, the movement under the force of gravity can also be assisted by further forces (for example, by electrostatic forces) or influenced in any other way (for example, viscous friction during movement along a guide element).

In order to ensure largely interaction-free application of a plurality of application layers and thereby reliably avoid mixing of the application media or damaging the layer(s) applied earlier by the subsequent application of one or more further layers, DE 197 16 647 A1 discloses the practice of drying the individual application layers before the next application layer is applied to the base. This process necessitates a sizable overall space to be made available for this applicator and also a considerable design outlay on drying apparatus, web guide elements and the like.

In the case of the applicator disclosed by DE 195 13 531 A1, the application medium is “fenced in” by auxiliary media, which are intended to keep damaging external influences away from the actual application medium curtain. As a result of this design, the applicator unit used to apply a single layer of application medium already has a complicated construction. In addition, mixing between the application medium and the auxiliary media cannot be avoided completely, which involves further problems.

### SUMMARY OF THE INVENTION

Although the material web may in principle be a paper web, a board web, a film web or a textile web, the invention is to be explained in more detail by using the example of the production of special papers. Special papers of this type can be, for example, carbonless copying papers (CB, CF or CFB paper), paper for inkjet printers, siliconized paper, thermal paper, light- and heat-sensitive photographic paper and similar papers.

The curtain applicator system according to the invention for applying at least a first layer and a second layer to a base has a simple construction that employs at least two curtain applicator units.

According to the invention two application medium curtains generated by a generic applicator strike the base with a spacing of between about 100 mm and about 500 mm. Surprisingly, a spacing in this range has been proven to be adequate in practice to achieve such great immobilization of the layer applied first that, in spite of the application of the second application layer onto the still wet first application layer (wet-on-wet application), the quality of the application result is not substantially impaired.

Rapid immobilization of the precoat, as a result of dewatering due to the capillary action of the material web, helps avoid mixing of the application media. Since such rapid immobilization is thereby advantageous, in a development of the invention, it is proposed that the water retention capacity of the application medium forming the first layer be lower than the water retention capacity of the application medium forming the second layer.

In order to reliably avoid mixing of the application media, it is further advantageous if the density of the application medium forming the first layer is at least 10% higher than the density of the application medium forming the second layer. By maintaining this density difference, it can be ensured that the second application medium “floats” on the layer formed by the first application medium and does not sink into it.

Furthermore, it is beneficial if the viscosity of the application medium forming the first layer is higher than the viscosity of the application medium forming the second layer, since this viscosity differential helps minimize damage to the precoat (first application medium) as a result of the tensile loading during the application of the top coat (second application medium).

In principle, various types of application media can be processed with the multi-layer applicator according to the invention. In quite general terms, the application medium can be an aqueous solution or an aqueous dispersion of solid particles (for example, an acrylate or butadiene-styrene dispersion). In this case, the solid particles can be mineral pigments or microscopic plastic particles such as plastic pigments, ink-filled microcapsules or starch. The solids content of the application medium may be between about 5% by weight and about 70% by weight. In addition, the application medium can have a Brookfield viscosity determined at 100 rev/min of between about 10 mPas and about 2000 mPas.

The application medium forming the first layer can be, for example, a starch solution, which has at least one of the properties: a solids content of between about 2% by weight and about 30% by weight; a Brookfield viscosity determined at 100 rev/min of between about 10 mPas and about 150 mPas; and a density of between about 0.8 g/cm3 and about 1.1 g/cm3. Here, the application medium forming the first layer can be applied to the base with a layer thickness of between about 2 ml/m² and about 20 ml/m².

In contrast, the application medium forming the second layer can advantageously be a dispersion of ink-filled microcapsules, which has at least one of the properties: a diameter of the microcapsules being between about 5 μm and about 12 μm; a solids content of between about 20% by weight and about 50% by weight; and a Brookfield viscosity determined at 100 rev/min of between about 100 mPas and about 400 mPas. In this case, various solvents and also synthetic or natural binders (for example, polyvinyl alcohol or starch) can be used. Furthermore, the application medium forming the second layer can be applied to the base with a layer thickness of between about 5 ml/m² and about 30 ml/².

The application media for forming the first and second application layers are intended in particular for the application to the production of graphic papers, specifically carbonless copying paper. The precoat (first application medium) in this case has, firstly, the task of providing a barrier layer for the ink-filled microcapsules contained in the top coat (second application medium) and thereby holding the latter securely on the surface of the carbonless copying paper. Secondly, however, it also has the task of equalizing the unevenness of the base paper and forming a smooth base for the top coat, so that the top coat can readily be formed with a thickness which is substantially constant over the entire surface of the material web. Achieving this evenness is of great importance for the likewise uniform distribution of the microcapsules and therefore for a uniform ink density of the lines achieved with the carbonless copying paper. The medium containing microcapsules may be applied particularly carefully with the aid of the curtain application method.

In one embodiment of the invention, at least one of the application media is applied to the base in a substantially finally metered manner (“1:1” application), which is advantageous from many points of view. Firstly, by this process the circulating quantities of application medium can be reduced. This metering permits the use of less powerful and therefore more cost-effective pumps, of color lines with a lower cross-sectional area, of smaller storage containers and the like. Secondly, the aging risk associated circulating a large quantity of enriching air in the application media can also be reduced. Finally, the “1:1” application also permits a reduction in the contamination of the application media with water, fibers or other substances which can be detached from the raw or already precoated material web.

In order to improve the application result, it is proposed that at least one guide element be arranged in the falling path of the curtain or veil and guide the curtain or veil along at least part of the falling path, substantially over its entire width. In this case, the words “guide along the falling path” can quite possibly also mean that the application medium curtain can be deflected out of the path corresponding to free fall by the guide element. The advantageous effect which this guide element has on the application medium curtain is most probably based on the fact that the application medium is initially braked somewhat upon contact with the guide element, which stabilizes the shape of the application medium curtain. With increasing movement of the application medium along the guide element, however, the falling speed and, more precisely, the flow speed of the application medium along the guide element, then increases again.

As a result of this stabilization of the application medium curtain, the total falling height of the curtain and, therefore, the extent of the force of gravity which can be achieved overall can be increased, as compared with a conventional free-falling application medium curtain, without penalties with regard to the quality of the application medium layer formed therewith. This setup makes it possible to approach more closely the film stretching limit, limited by the physical properties of the application medium, at which oscillatory waves having a detrimental effect on the uniformity of the coating are formed in the metered film, than was hitherto possible with a free-falling application medium curtain.

In order to increase the quality of the application result, it may also be advantageous to assign an apparatus for influencing the pressure which prevails in the area between the curtain applicator units. In particular, the apparatus advantageously influences the pressure on the application medium curtains and the base. Depending on the application media respectively used, the production of one of a vacuum and a positive pressure may be beneficial. If a vacuum is produced, firstly, the separation of the first application medium curtain from a guide doctor (that is to say, a guide element which is set against the base to weaken an air boundary layer carried along with the latter) and, secondly, the wetting of the top coat on the precoat can be improved. By use of a positive pressure prevailing in the area between the two applicator units, the precoat can be anchored better on the moving material web and, additionally, both curtains (both for precoat and top coat) can be stabilized, since the positive pressure reduces their tendency to flutter.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 represents a schematic side view of an applicator according to the invention; and

FIG. 2 represents a schematic view of an exemplary application system in which the applicator according to FIG. 1 is used.

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION OF THE INVENTION

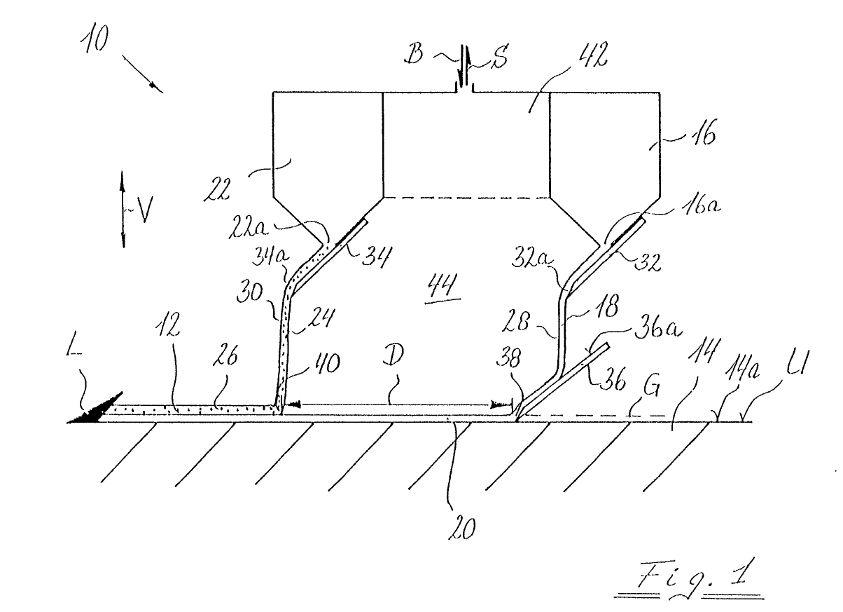

In FIG. 1, an applicator 10 is used to apply a multi-layer coating 12 to a base U, for example a paper web 14, moving in running direction L.

Applicator 10 includes a first curtain applicator unit 16, which applies a first application medium 18, for example a starch solution or starch suspension, as a precoat 20 to surface 14a of paper web 14. In addition, applicator 10 includes a second curtain applicator unit 22, which applies application medium 24 as a top coat 26 onto precoat 20, applied by first curtain applicator unit 16. Application medium 24 of top coat 26 can be, for example, a dispersion or suspension of ink-filled microcapsules, these microcapsules being indicated dotted in FIG. 1.

Both applicator units 16 and 22 discharge application medium 18 and 24 in the form of an application medium curtain 28 and 30, respectively. In this case, a guide blade 32 and 34 is provided immediately adjacently to discharge opening 16a and 22a of applicator units 16, 22, its length in the flow direction of application medium 18 or 24 being dimensioned or set, as a function of the properties of respective application medium 18, 24, in such a way that application medium curtain 28 or 30 subsequently takes a substantially vertical course (direction V) at breakaway edge 32a and 34a, respectively. That is to say neither exhibits the so-called “teapot effect” nor “shoots out” over breakaway edge 32a or 34a in a parabolic shape.

In the area of precoat (i.e., first) applicator unit 16, a doctor element 36 is also set against surface 14a of paper web 14. Doctor element 36 is used firstly to weaken or eliminate air boundary layer G carried along by paper web 14 on surface 14a thereof. Secondly, doctor element 36 intercepts application medium curtain 28, stabilizes the latter on account of the viscous frictional forces between application medium 18 and surface 36a of doctor element 36, and leads application medium 18 towards surface 14a of paper web 14.

According to the embodiment, two points of incidence 38 and 40 of precoat curtain 28 and of top-coat curtain 30 are at a spacing D from each other, which is between about 100 mm and about 500 mm. Spacing D is sufficient to immobilize precoat 20 adequately on paper web surface 14a, so that impairment or even damage to precoat 20 as a result of being struck by topcoat curtain 30 is not to be feared.

Furthermore, a suction/blower box 42 is provided between curtain applicator units 16 and 22. With the aid of suction/blower box 42, the pressure in a space 44, which is enclosed by applicator units 16 and 22, application medium curtains 28 and 30, paper web 14 and suction/blower box 42 itself, can be varied. The extraction/suction of air to produce a vacuum in space 44, and blowing air in to produce a positive pressure in space 44, are indicated in FIG. 1 by arrows S (extraction/suction) and B (blowing).

In the case where a vacuum is produced, firstly, the separation of precoat curtain 28 from guide doctor 36 and, secondly, the wetting of top coat 26 on precoat 20 can be improved. By use of a positive pressure prevailing in space 44, firstly, precoat 20 can be anchored better on paper web 14 and, secondly, both curtains 28 and 30 can be stabilized, since the positive pressure reduces their tendency to flutter.

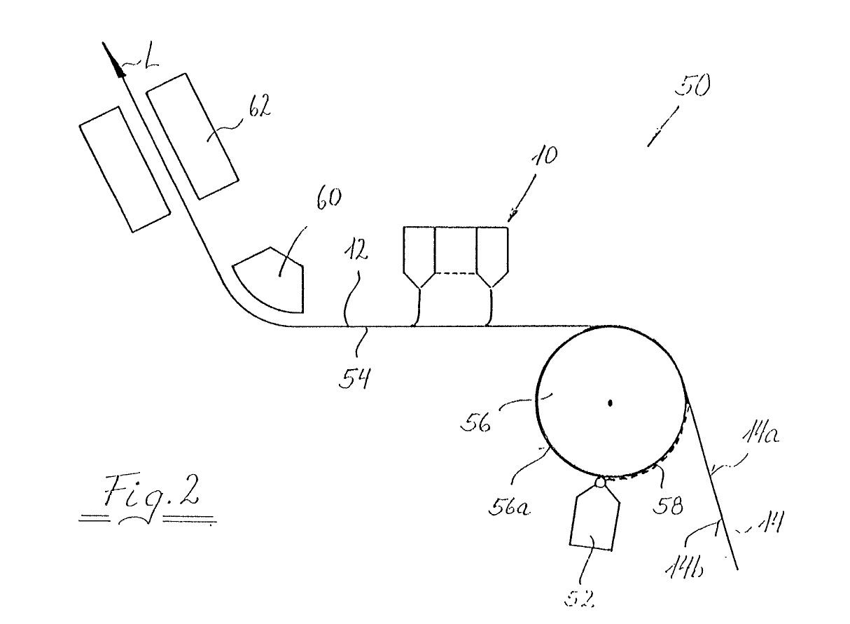

FIG. 2 shows an example of an application system 50 in which applicator 10 can be employed. Material web 14 moving in running direction L is, in this case, provided on surface 14a thereof with a “wet-on-wet” application 12 by curtain applicator 10. Furthermore, an application layer 54 is also applied to back 14b of material web 14. Coating back 14b thereof is carried out by an indirect applicator unit 52, which initially applies application medium 58 to surface 56a of a transfer roll 56, which then conveys application medium 58 towards material web 14. In application system 50 illustrated, roll 56 is also used as a web deflection element for material web 14.

Provided downstream of applicator 10, in running direction L of material web 14, is a further web deflection element 60. In the embodiment illustrated, web guide element 60 is constructed as a web deflection element which operates without contact, preferably as an airturn, as it is known, in order to prevent any impairment of “wet-on-wet” application 12 by web guide element 60. A drying apparatus 62 then follows, downstream of web guide element 60.

Application system 50 according to FIG. 2 is distinguished by particularly simple web guidance, material web 14 running unsupported, in particular in the area of curtain applicator 10. Material web 14 can therefore be coated three times in a very careful manner.

Although the invention has been explained above using the example of producing paper coated on one side with ink-filled microcapsules on its front side (CF paper), it goes without saying that the invention can likewise also be used for producing paper coated on one side with microcapsules on its back (CB paper) or paper coated on both sides (CFB paper).

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An apparatus for applying at least one first layer of a first application medium and at least one second layer of a second application medium to a material web, each of the first application medium and the second application medium being one of a liquid medium and a pasty medium, the material web having a web surface, the at least one first layer and the at least one second layer being first applied onto a moving base, the moving base being the web surface in the case of direct application thereof, the moving base being a transfer element in the case of indirect application thereof, the transfer element being configured for transferring each said at least one first layer and each said at least one second layer applied thereon to the web surface of the material web, said apparatus comprising:
a first curtain applicator unit including a first discharge nozzle, said first curtain applicator unit configured for discharging the first application medium through said first discharge nozzle in a form of a first curtain onto the moving base, the first curtain moving substantially under the force of gravity; and
a second curtain applicator unit including a second discharge nozzle, said second curtain applicator unit configured for discharging the second application medium through said second discharge nozzle in a form of a second curtain onto the moving base, the a second curtain moving substantially under the force of gravity, said first applicator unit being positioned relative to said second applicator unit such that a spacing of about 100 mm to about 500 mm separates the first curtain and the second curtain.

2. The apparatus of claim 1, wherein the first application medium has a first water retention capacity, the second application medium having a second water retention capacity, the first water retention capacity being lower than the second water retention capacity.

3. The apparatus of claim 1, wherein the first application medium has a first density, the second application medium having a second density, the first density being at least about 10% greater than the second density.

4. The apparatus of claim 1, wherein the first application medium has a first viscosity, the second application medium having a second viscosity, the first viscosity being greater than the second viscosity.

5. The apparatus of claim 1, wherein at least one of the first application medium and the second application medium is one of an aqueous solution and an aqueous dispersion of solid particles.

6. The apparatus of claim 5, wherein said at least one of the first application medium and the second application medium is one of an acrylate dispersion and a butadiene-styrene dispersion.

7. The apparatus of claim 5, wherein the solid particles are one of mineral pigments and microscopic plastic particles.

8. The apparatus of claim 5, wherein the solid particles are one of plastic pigments, ink-filled microcapsules and starch.

9. The apparatus of claim 1, wherein at least one of the first application medium and the second application medium has a solids content in an approximate range of 5% by weight to 70% by weight.

10. The apparatus of claim 1, wherein at least one of the first application medium and the second application medium has a Brookfield viscosity determined at 100 rev/min of between about 10 mPas and about 2000 mPas.

11. The apparatus of claim 1, wherein the first application medium is used for forming a barrier layer, the first application medium having at least one of the following properties:
a solids content in an approximate range of 2% by weight to 30% by weight;
a Brookfield viscosity determined at 100 rev/min of between about 10 mPas and about 150 mPas; and
a density of between about 0.8 g/cm³ and about 1.1 g/cm³.

12. The apparatus of claim 11, wherein the first application medium is a starch solution.

13. The apparatus of claim 1, wherein said first curtain applicator unit is configured for applying an amount of the first application medium applied to the moving base, said amount being between about 2 ml/m² and about 20 ml/m².

14. The apparatus of claim 1, wherein the second application medium is a dispersion of ink-filled microcapsules, each of the microcapsules having a microcapsule diameter associated therewith, the second application medium having at least one of the following properties:
each of the microcapsules having a microcapsule diameter of between about 5 μm and about 12 μm;
a solids content of between about 20% by weight and about 50% by weight; and
a Brookfield viscosity determined at 100 rev/min of between about 100 mPas and about 400 mPas.

15. The apparatus of claim 1, wherein said second curtain applicator unit is configured for applying an amount of the second application medium applied to the moving base, said amount being between about 5 ml/m² and about 30 ml/m².

16. The apparatus of claim 1, wherein at least one of said first curtain applicator unit and said second curtain applicator unit is configured for applying the first application medium and the second application medium, respectively, to the moving base in a substantially finally metered manner.

17. The apparatus of claim 1, further comprising a pressure-differential device for producing one of a vacuum and a positive pressure, said pressure-differential device being operatively positioned between said first curtain applicator unit and said second curtain applicator unit.

18. The apparatus of claim 1, wherein each of the first curtain and the second curtain has a curtain flow path and a curtain width associated therewith, the apparatus further comprising at least one guide element, each said guide element being arranged within said curtain flow path of one of the first curtain and the second curtain, each said guide element configured for guiding the one of the first curtain and the second curtain along at least a part of the curtain flow path and substantially over the curtain width associated therewith.

19. The apparatus of claim 1, wherein each of the first curtain and the second curtain has a curtain height of between about 40 mm and about 400 mm.

20. The apparatus of claim 1, wherein said first curtain applicator unit and said second curtain applicator unit are configured for discharging the first application medium and the second application medium, respectively, onto the moving base at a rate of between about 4 l/min and about 100 l/min per meter of working width.

21. The apparatus of claim 1, wherein the moving base has a base running speed associated therewith, the base running speed being up to 3000 m/min in the case of coating graphic papers, the base running speed being at least 200 m/min in the case of coating cardboard.

22. The apparatus of claim 1, wherein said first curtain applicator unit and said second curtain applicator unit are together configured for producing a grammage of coated material web between about 30 g/m² and about 150 g/m² in the case of coating graphic papers and between about 150 g/m² and 1000 g/m² in the case of coating cardboard.

23. The apparatus of claim 1, wherein the apparatus is configured for processing a material web that is one of a paper web, a cardboard web, a film web and a textile web.
